(19) United States
(12) Patent Application Publication
(10) Pub. No.: US 2024/0289650 A1
(43) Pub. Date: Aug. 29, 2024

(54) ELECTRONIC DEVICE FOR MAKING DECISION AND METHODS THEREOF

(71) Applicant: CRYPTO LAB INC., Seoul (KR)

(72) Inventors: Jung Hee Cheon, Seoul (KR); Hyeongmin Choe, Seoul (KR); Jai Hyun Park, Seoul (KR)

(21) Appl. No.: 18/423,732

(22) Filed: Jan. 26, 2024

(30) Foreign Application Priority Data
Jan. 26, 2023 (KR) 10-2023-0010320
Jan. 23, 2024 (KR) 10-2024-0010410

(51) Int. Cl. G06N 5/04

(52) U.S. Cl. CPC G06N 5/04

(57) ABSTRACT

Disclosed is an electronic device. The device includes: a memory storing a tree-structured decision-making model for making a decision; an interface for receiving an input value; and a processor configured to acquire a result value of a tree structure that corresponds to the input value by performing a reduction operation of reducing the tree structure at least once, wherein the reduction operation includes a comparison calculation of comparing the input value with a value of one of nodes included in the tree structure is performed, and a comparison calculation result is added to nodes at corresponding positions in a plurality of lower tree structures branching from the node, and then the nodes are combined with each other.

### FIELD OF THE INVENTION

The present disclosure relates to an electronic device for making a decision and a method thereof.

### DESCRIPTION OF THE PRIOR ART

In accordance with the development of communication technology and a growing spread of electronic devices, efforts are continuously being made to maintain communication security between the electronic devices. Accordingly, encryption/decryption technology is used in most communication environments.

In case that a message encrypted by the encryption technology is delivered to the other party, the other party may be required to perform decryption to use the message. In this case, the other party may waste resources and time in a process of decrypting the encrypted data. In addition, the message may be easily leaked to a third party in case that the message temporarily decrypted by the other party for calculation is hacked by the third party.

A homomorphic encryption method is being studied to solve this problem. The homomorphic encryption method may acquire the same result as an encrypted value after performing the calculation on a plaintext even if the calculation is performed on an encrypted message itself without decrypting the encrypted data. Therefore, various calculations may be performed without decrypting the encrypted message.

The data encrypted by the homomorphic encryption technology may be used in various fields. As an example, various decisions may be made by various artificial intelligence models based on the encrypted data. A decision tree may be used as one decision-making method.

However, in case of applying a conventional decision tree to homomorphically encrypted data, a comparison result value may be output in the form of encrypted data, and it is thus impossible to make a decision in the same way as general data.

In detail, in a homomorphic encryption scheme, a comparison calculation may be more difficult and time-consuming than another calculation. According to a conventional method, the comparison calculation may be required to be performed on all decision nodes included in the decision tree. Therefore, an amount of calculation burden may be greatly increased as a depth of the decision tree is increased.

### SUMMARY OF THE INVENTION

The present disclosure provides an electronic device which may make a decision efficiently based on homomorphically encrypted data and a decision tree, and a method thereof.

According to an embodiment of the present disclosure, provided is an electronic device including: a memory storing a tree-structured decision-making model for making a decision; an interface for receiving an input value; and a processor configured to acquire a result value of a tree structure that corresponds to the input value by performing a reduction operation of reducing the tree structure at least once, wherein the reduction operation includes a comparison calculation of comparing the input value with a value of one of nodes included in the tree structure is performed, and a comparison calculation result is added to nodes at corresponding positions in a plurality of lower tree structures branching from the node, and then the nodes are combined with each other.

The processor may be configured to perform a preprocessing operation of re-aligning positions of the nodes for the largest number of nodes to be disposed in their corresponding positions among the nodes included in the plurality of lower tree structures with regard to the plurality of lower tree structures branching from one node in the tree structure, and store the re-aligned positions in the memory.

The processor may be configured to perform a preprocessing operation of matching depths of final leaf nodes of the lower tree structures each branching from a root node of the tree structure with each other by adding at least one duplicate node to the leaf node disposed at a middle depth in the tree structure.

The processor may be configured to generate a position identification vector corresponding to a root node in the tree structure, perform the comparison calculation of comparing the input value with a calculated value acquired by calculating the position identification vector and a value of a next node branching from the root node, perform an operation of segmenting the tree structure a predetermined number of times while reflecting a comparison calculation result to the next node to update the position identification vector to the position identification vector corresponding to a next depth, combine the segmented tree structures with each other to acquire a reduced tree structure by using the position identification vector updated in the segmentation operation, and output the result value corresponding to the input value by performing the reduction operation on the reduced tree structure at least once.

According to an embodiment of the present disclosure, provided is a method of making a decision by an electronic device which stores a tree-structured decision-making model for making a decision, the method including: receiving an input value; and acquiring a result value of a tree structure that corresponds to the input value by performing a reduction operation of reducing the tree structure at least once, wherein, the reduction operation includes a comparison calculation of comparing the input value with a value of one of nodes included in the tree structure is performed, and a comparison calculation result is added to nodes at corresponding positions in a plurality of lower tree structures branching from the node, and then the nodes are combined with each other.

The method may further include performing a preprocessing operation of re-aligning positions of the nodes for the largest number of nodes to be disposed in their corresponding positions among the nodes included in the plurality of lower tree structures with regard to the plurality of lower tree structures branching from one node in the tree structure.

The method may further include performing a preprocessing operation of matching depths of final leaf nodes of the lower tree structures each branching from a root node of the tree structure with each other by adding at least one duplicate node to the leaf node disposed at a middle depth in the tree structure.

The acquiring of the result value of the tree structure that corresponds to the input value may include: generating a position identification vector corresponding to a root node in the tree structure, performing the comparison calculation of comparing the input value with a calculated value acquired by calculating the position identification vector and a value of a next node branching from the root node, and performing a segmentation operation of segmenting the tree structure a predetermined number of times while reflecting a comparison calculation result to the next node to update the position identification vector to the position identification vector corresponding to a next depth; and combining the segmented tree structures with each other to acquire a reduced tree structure by using the position identification vector updated by the predetermined number of times, and outputting the result value corresponding to the input value by performing the reduction operation on the reduced tree structure at least once.

According to the various embodiments described above, the electronic device may make a decision efficiently based on the homomorphically encrypted data and the decision tree.

### BRIEF DESCRIPTION OF THE DRAWINGS

FIG. 1 is a view for explaining an operation of an electronic device according to an embodiment of the present disclosure.

FIG. 2 is a view for explaining a configuration of a decision tree.

FIG. 3 is a block diagram showing a configuration of the electronic device according to at least one embodiment of the present disclosure.

FIGS. 4 and 5 are views for explaining a preprocessing operation for the decision tree.

FIGS. 6, 7 and 8 are view for explaining operations of an electronic device according to various embodiments of the present disclosure.

FIGS. 9, 10 and 11 are flowcharts for explaining a method of making a decision by an electronic device according to various embodiments of the present disclosure.

### DESCRIPTION OF THE PREFERRED EMBODIMENT

Hereinafter, the present disclosure is described in detail with reference to the accompanying drawings. Encryption/decryption may be applied as necessary to a process of transmitting data (or information) that is performed in the present disclosure, and an expression describing the process of transmitting the data (or information) in the present disclosure and the claims should be interpreted as including cases of the encryption/decryption even if not separately mentioned. In the present disclosure, an expression such as “transmission/transfer from A to B” or “reception from A to B” may include transmission/transfer or reception while having another medium included in the middle, and may not necessarily express only the direct transmission/transfer or reception from A to B.

In describing the present disclosure, a sequence of each operation should be understood as non-restrictive unless a preceding operation in the sequence of each operation needs to logically and temporally precede a subsequent operation. That is, except for the above exceptional case, the essence of the present disclosure is not affected even though a process described as the subsequent operation is performed before a process described as the preceding operation, and the scope of the present disclosure should also be defined regardless of the sequence of the operations. In addition, in the specification, “A or B” may be defined to indicate not only selectively indicating either one of A and B, but also including both A and B. In addition, a term “including” in the present disclosure may have a meaning encompassing further including other components in addition to components listed as being included.

The present disclosure only describes essential components necessary for describing the present disclosure, and does not mention components unrelated to the essence of the present disclosure. In addition, it should not be interpreted as an exclusive meaning that the present disclosure includes only the mentioned components, but should be interpreted as a non-exclusive meaning that the present disclosure may include other components as well.

In addition, in the present disclosure, a “value” may be defined as a concept that includes a vector or a polynomial form as well as a scalar value.

Mathematical calculations and computations of each step in the present disclosure described below may be implemented as computer calculations by a known coding method or coding designed to be suitable for the present disclosure to perform the corresponding calculations or computations.

Specific equations described below are exemplarily described among possible alternatives, and the scope of the present disclosure should not be construed as being limited to the equations mentioned in the present disclosure.

For convenience of description, the present disclosure defines the following notations:
a→D: Select an element a according to distribution D.
s1, s2 ∈ R: Each of S1 and S2 is an element belonging to a set R. mod(q): Perform modular calculation with an element q.
└-┘: Round an internal value.

Hereinafter, various embodiments of the present disclosure are described in detail with reference to the accompanying drawings.

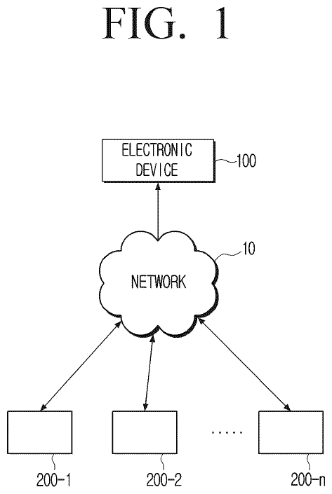

FIG. 1 is a view for explaining an operation of an electronic device according to at least one embodiment of the present disclosure. Referring to FIG. 1, an electronic device 100 may be connected to a plurality of external devices 200-1 to 200-n through a network 10.

For convenience of explanation, hereinafter, the devices 200-1 to 200-n connected to the electronic device 100 are collectively referred to as the external device. However, the devices 200-1 to 200-n may respectively be implemented as various types of electronic devices each having a communication function.

The electronic device 100 may be implemented in any of various forms such as a server device, a personal computer (PC), a laptop PC, a mobile phone, a tablet PC, or a kiosk. In case of being implemented as the server device, the electronic device 100 may be implemented as any of various computing devices such as a workstation, a cloud, a data drive, or a data station.

The network 10 may include both of a wired network and a wireless network. The wired network may include a cable network, a telephone network, or the like, and the wireless network may include any network for transmitting and receiving a signal through a radio wave. The wired network and the wireless network may also be connected to each other.

Each of the external devices 200-1 to 200-n may generate an encryption key. The encryption key may include a secret key and a public key. Each of the external devices 200-1 to 200-n may encrypt various messages by using the generated encryption key, and transmit the encrypted message to the electronic device 100 through the network 10. In the present disclosure, the message may include various information or data to be transmitted, the encryption may be homomorphic encryption, and the encrypted message may be a homomorphically encrypted message.

Each of the external devices 200-1 to 200-n may allow an error, that is encryption noise computed in a process of performing the homomorphic encryption to be included in the encrypted message. In detail, the homomorphically encrypted message generated by each of the external devices 200-1 to 200-n may be generated for a result value including the message and an error value to be restored in case that the encrypted message is later decrypted using the secret key.

As an example, the homomorphically encrypted message generated by each of the external devices 200-1 to 200-n may be generated to satisfy the following feature in case of being decrypted later using the secret key.

$$Dec ( ct , sk ) = 〈 ct , sk 〉 = M + e ( mod q ) \qquad 〈 Equation 1 〉$$

Here, < and > indicate dot product calculation (or usual inner product), ct indicates the encrypted message, sk indicates the secret key, M indicates a plaintext message, e indicates the encryption error value, and mod q indicates a modulus of the encrypted message. q needs to be chosen larger than the result value M multiplied by a scaling factor Δ to the message. In case that an absolute value of the error value e is sufficiently smaller than M, a decryption value M+e of the encrypted message may be a value that may replace an original message by the same precision in significant figure calculation. Among decrypted data, the error may be disposed on the least significant bit (LSB) side, and M may be disposed on the next least significant bit side.

In case that a size of the message is too small or too large, the size may be adjusted using the scaling factor. In case that the scaling factor is used, not only a message in an integer form but also a message in a real number form may be encrypted, and its usability may thus be greatly increased. In addition, the size of the message may be adjusted using the scaling factor to thus also adjust a size of an effective region, that is, a region where the messages exist in the encrypted message after the calculation is performed.

In some embodiments, the modulus q of the encrypted message may be set and used in various forms. As an example, the modulus of the encrypted message may be set in a form of an exponential power q=Δ^{L} of the scaling factor Δ. In case that Δ is 2, the modulus may be set to a value such as q=2¹⁰.

In addition, the homomorphically encrypted message according to the present disclosure is described assuming that a fixed point is used. However, the homomorphically encrypted message may also be applied even in case of using a floating point.

Each of the external devices 200-1 to 200-n may directly store the generated encrypted message or provide the same to the electronic device 100. Omitted is a description of a method for specifically generating the homomorphically encrypted message by each of the external devices 200-1 to 200-n.

Meanwhile, at least one of the external devices 200-1 to 200-n or another external device may each transmit an input value to make a decision by using a decision tree stored in the electronic device 100. The input value may be various information or data that a user inputs for making a decision. The input value may be alternatively referred to as a user query.

The input value may include the number of input values corresponding to the number of decision nodes included in the decision tree. For example, if a total of 7 decision nodes are included in the decision tree, a total of 7 input values may be transmitted from the external device for making a decision.

The electronic device 100 may make a decision by using various data transmitted from each of the external devices 200-1 to 200-n and the decision tree.

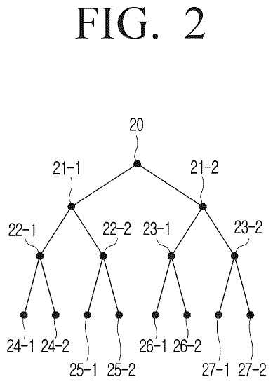

FIG. 2 shows an example of a configuration of the decision tree. In detail, FIG. 2 shows an example of a binary decision tree in which a variable area is divided into two parts each time the area branches. The decision tree may include the node and a branch connecting the nodes to each other. The node may be data on a question to make a decision or an answer to a correct answer. In addition, the decision tree may be implemented as a set of algorithms or software modules to process these data.

The nodes in the decision tree may be divided into a decision node and a leaf node based on their positions. The decision node may be a node for asking a question to make a decision. The top node 20 among the decision nodes may be referred to as a root node, and its depth may be zero. A node disposed at an end of each branch of the decision tree may be referred to as the leaf node.

The leaf node may be alternatively referred to as a terminal node. On the other hand, a node disposed between the root node and the leaf node may be referred to as an intermediate node. In addition, a lower node branching from one node may be referred to as a child node of that one node, and an upper node of the child node may be referred to as a parent node.

FIG. 2 shows the binary decision tree which has a depth ranging from zero to 3, and in which two tree structures branch from a root node 20 to each of intermediate nodes 21-1, 21-2, 22-1, 22-2, 23-1, and 23-2. Accordingly, eight leaf nodes 24-1, 24-2, 25-1, 25-2, 26-1, 26-2, 27-1, and 27-2 may be finally prepared. The data on the question or answer corresponding to each node, the input value, a result value, and the like may each be an encrypted message that is homomorphically encrypted, are not necessarily limited thereto, and at least one of these data may be data in a plaintext form. The data of each node may be alternatively referred to as a node value.

In case of receiving the input value, the electronic device 100 may provide an output value corresponding to the input value based on a tree-structured decision-making model and the homomorphically encrypted data.

As described above, the electronic device 100 may make various decisions by using the tree-structured decision-making model. Hereinafter, the description describes a specific method of making a decision by the electronic device.

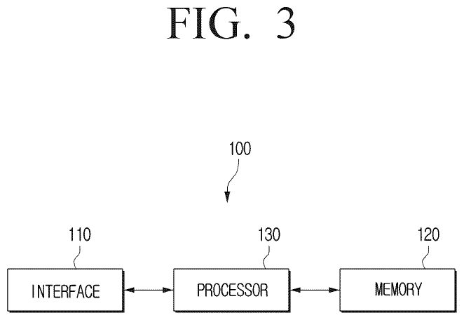

FIG. 3 is a block diagram showing a configuration of the electronic device 100 according to at least one embodiment of the present disclosure. Referring to FIG. 3, the electronic device 100 may include an interface 110, a memory 120, and a processor 130.

The interface 110 may be a component for providing interaction between two or more systems, devices, programs, or users. The interface 110 may include at least one of a communication interface, an input/output interface, or a user interface.

The communication interface may be a component for performing communication with the external device through wired or wireless communication. As shown in FIG. 1, in case of communicating with a plurality of the external devices 200-1 to 200-n, the communication interface may receive password data generated by the external devices 200-1 to 200-n. In addition, the communication interface may receive the input value from a device requesting a decision-making. The communication interface may also be alternatively referred to as a communicator.

The input/output interface may be a component for transmitting or receiving various signals, data, or the like from a device connected thereto by wire. The input/output interface may include various ports such as a universal serial bus (USB) port and a high definition multimedia interface (HDMI) port for connecting various external devices such as a microphone, a keyboard, and a joystick thereto. The input/output interface may also be alternatively described as a connection port. The electronic device 100 may receive the above-described password data or the like from a memory device or the external device, connected thereto through the input/output interface.

The user interface may be a component for receiving various user commands directly from the user. The user interface may be implemented as a touch screen, a touch pad, a button, or the like. For example, the user interface may be implemented as the touch screen. In this case, the user may input the input value in such a way that the user draws by touching the touch screen with the user's hand or a touch pen, or inputs the input value by using a soft keyboard displayed on the touch screen.

As described above, the user may input various data and the input value into the electronic device 100 through the various types of interface 110 described above.

The memory 120 may be a component for storing various software, instructions, control codes, and data necessary for operating the electronic device 100. The memory 120 may be implemented as at least one of various memories such as a dynamic random access memory (DRAM), a static RAM (SRAM), a synchronous dynamic RAM (SDRAM), an one time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD).

The memory 120 may store a tree-structured decision-making model for making a decision. The decision-making model may be alternatively referred to as the decision tree described above.

The decision tree may be a prediction model that provides an appropriate output value based on the input value for an item, and may be used in statistical analysis, data mining, machine learning, or the like. The decision-making model may include the data corresponding to various questions or answers used in making a decision and at least one software module or the like for performing various calculations stage by stage based on the data. The data used by the decision-making model may be the homomorphically encrypted message described above.

The processor 130 may be a component for controlling an overall operation of the electronic device 100. The processor 130 may include at least one of a digital signal processor (DSP), a micro processor, a central processing unit (CPU), a micro controller unit (MCU), a micro processing unit (MPU), a controller, an application processor (AP), or a communication processor (CP), an advanced reduced instruction set computer (RISC) machine (ARM) processor, or an artificial intelligence (AI) processor, and may be defined in this term. In addition, the processor 130 may be implemented in a system-on-chip (SoC) or a large scale integration (LSI), in which a processing algorithm is embedded, or may be implemented in the form of a field programmable gate array (FPGA). The processor 130 may perform various functions by executing computer executable instructions stored in the memory 120.

The processor 130 may update the data of the decision-making model by using the received data in case of receiving the data from each of the external devices 200-1 to 200-n through the interface 110. In detail, the processor 130 may determine a depth of the decision-making model, and generate a tree structure by aligning the questions and answers corresponding to the nodes at each depth, and then store the same in the memory 120. In another example, the decision-making model may be generated in advance by another device and then loaded into the memory 120. Alternatively, the processor 130 may receive the decision-making model from at least one of the external devices 200-1 to 200-n through the interface 110 and store the same in the memory 120. Alternatively, the processor 130 may reflect additional data and perform an update for adding the depth, the node, or the branch to the pre-stored decision-making model in case of receiving the additional data from at least one of the external devices 200-1 to 200-n.

In this state, the processor 130 may make a decision in various ways by using the decision-making model in case of receiving the input value through the interface 110.

A prior decision tree making a decision based on general data (that is, unencrypted plain text) may process the data by performing a comparison calculation of comparing the data of the root node with the input value, selecting one of two lower tree structures branching from the root node based on a comparison result, and performing the comparison calculation again with the top node of the lower tree structure. If the top node of the lower tree structure is the leaf node, the decision tree may output data corresponding to the leaf node as its output value.

It is possible to effectively use this method for the data in the plaintext form. However, it is difficult to use this method for the data in the form of the homomorphically encrypted message. That is, according to the prior art, the comparison calculation may be required to be performed between the data of all visited nodes and the input value. However, a comparison calculation result itself for the homomorphic encrypted message may have a form of the encrypted message. Therefore, the deeper the depth, the more difficult and time-consuming the comparison calculation.

In various embodiments described below, in order to solve these problems, the processor 130 may reduce a calculation burden by performing a reduction operation of reducing the decision tree, performing a segmentation operation of segmenting the decision tree by using a position identification vector, or using the reduction operation and the segmentation operation together. Details of these operations are described again in more detail below.

Meanwhile, the processor 130 may first perform a preprocessing operation of reorganizing a shape of the decision tree into a form suitable for the reduction operation or the segmentation operation. The preprocessing operation may be an operation of adjusting the position or depth of the node included in each partial tree structure in the decision tree.

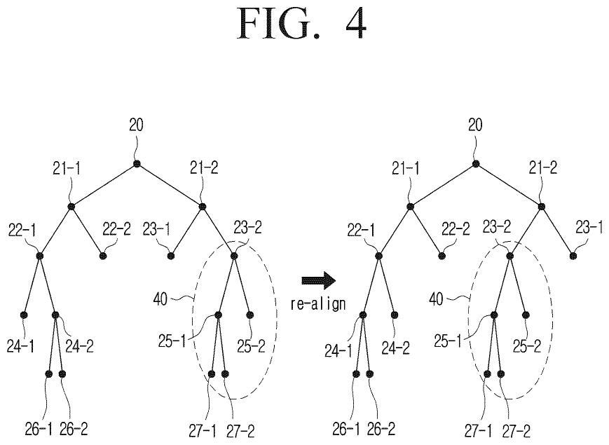

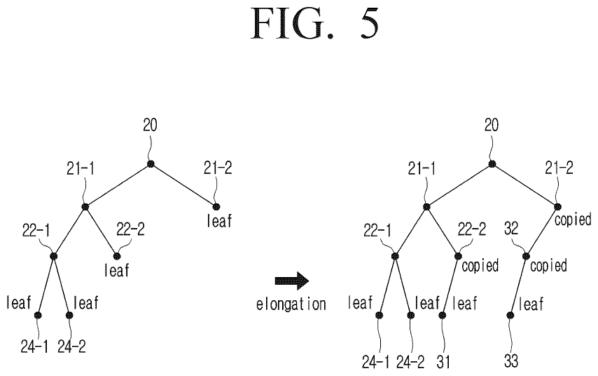

FIGS. 4 and 5 are views for explaining various preprocessing operations.

FIG. 4 shows an operation of re-aligning the nodes.

The processor 130 may perform the preprocessing operation of re-aligning the positions of the nodes for the largest number of nodes to be disposed in their corresponding positions among the nodes included in the plurality of lower tree structures with regard to the plurality of lower tree structures branching from one node in the tree structure.

Referring to FIG. 4, two lower tree structures may branch from the root node 20, and the top nodes 21-1 and 21-2 of each lower tree structure may be connected to their lower nodes. The node 22-2 secondly connected to the second node 21-1 and the node 23-1 firstly connected to the third node 21-2 may correspond to the leaf nodes. On the other hand, the plurality of nodes 25-1, 25-2, 27-1, and 27-2 may be sequentially connected to the node 23-2 secondly connected to the third node 21-2.

For convenience of explanation, assume that based on the root node 20, a left lower tree structure starting from the second node 21-1 is a first lower tree structure, and a right lower tree structure starting from the third node 21-2 is a second lower tree structure. In this case, the lower nodes corresponding to some lower nodes 24-1, 24-2, 26-1, and 26-2 in the first lower tree structure may not exist in the second lower tree structure.

The processor 130 may perform a re-alignment operation of changing a position of a lower tree structure 40 starting from the node 23-2 in the second lower tree structure with a position of the surrounding node 23-1 to dispose the nodes in positions corresponding to these lower nodes.

Referring to the re-aligned tree structure, it may be seen that each node of the first lower tree structure and each node of the second lower tree structure are disposed in their corresponding positions.

FIG. 5 shows the operation of adjusting the depth of the node. Referring to FIG. 5, if the depth of the root node 20 is zero, the two lower nodes 21-1 and 21-2 connected to the root node 20 may correspond to depth 1 in the tree structure at depth 4 that starts from the root node 20. Referring to FIG. 5, it may be seen that the node 21-2 at depth 1 and the node 22-2 at depth 2 may be the leaf nodes disposed at a middle depth.

The processor 130 may perform the preprocessing operation of matching depths of final leaf nodes of all the lower tree structures with each other by adding at least one duplicate node to the leaf node disposed at the middle depth in the tree structure.

In detail, the processor 130 may generate duplicate nodes 32 and 33 each having the same data as the data of the leaf node 21-2 disposed at depth 1 in the tree structure of FIG. 5, and then sequentially add the duplicate nodes to the leaf node 21-1. Accordingly, the final leaf node may become the last duplicate node 33. In addition, the processor 130 may generate the duplicate node 31 having the same data as the data of the leaf node 22-2 disposed at depth 2, and then connect the duplicate node to the leaf node 21-2. As described above, assume that the lower tree structures branching from the root node 20 may be referred to as the first and second lower tree structures. In this case, each depth of the final leaf nodes of the first and second lower tree structures may match depth 3.

The preprocessing operations described with reference to FIGS. 4 and 5 may be performed in advance before the decision-making model is stored in the memory 120. Alternatively, the processor 130 may perform the above-described preprocessing operation on the updated decision-making model and store the same in the memory 120 in case that decision-making model is updated by adding new data thereto or deleting some data therefrom. In this way, the decision-making model may be updated frequently or periodically.

Referring to FIGS. 4 and 5, the description describes examples of two different preprocessing operations. However, in some embodiments, these preprocessing operations may be performed simultaneously in one embodiment, or may be performed separately.

The processor 130 may use the decision-making model preprocessed in this way, is not necessarily limited thereto, and also use the decision-making model in an incomplete state without performing any separate preprocessing operation.

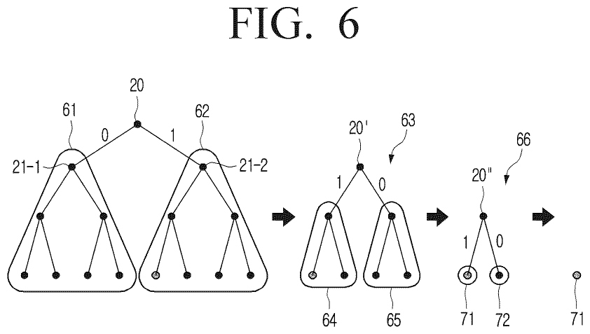

FIG. 6 is a view showing a method of making a decision by an electronic device according to an embodiment of the present disclosure. In detail, FIG. 6 is a view for explaining a reduction method of making a decision by sequentially reducing the decision tree.

For convenience of explanation, FIG. 6 shows the decision tree having a completely symmetrical structure. However, the decision tree is not necessarily limited thereto.

Referring to FIG. 6, assume that based on the root node 20, the left lower tree structure is a first lower tree structure 61, and the right lower tree structure is a second lower tree structure 62. In this case, the processor 130 may first perform the comparison calculation on an input value x and data d of the root node 20. The comparison calculation may be expressed as the following equation.

$$\\ β = comp ( x , d ) \qquad 〈 Equation 2 〉$$

$$Here ,$$

$$β may be zero if x < d ,$$

$$and$$

$$β may be 1 if x < d .$$

The input value may include the same number as the number of the decision nodes in the decision tree. For example, as shown in FIGS. 6, the input value may range from x1 to x7, and the data of each decision node may range from d1 to d7 if a total of 7 decision nodes exist.

The processor 130 may perform the reduction operation of reducing the tree structure by applying the comparison calculation result to the respective nodes at the corresponding positions in the first and second lower tree structures 61 and 62, and then combining the corresponding nodes with each other at least once.

The processor 130 may use xₗ and xᵣ, which are the input values corresponding to the decision nodes among the input values in case of combining the two decision nodes to which data dₗ and dᵣ are respectively assigned. That is, data (1−β)dₗ+βdᵣ may be assigned to a new combined node. In addition, the input value corresponding to the new node may be (1−β)xₗ+βxᵣ. Meanwhile, data (1−β)dₐ+βd_{b} may be assigned to a new combined leaf node in case of combining two leaf nodes, to which data dₐ and do are respectively assigned, with each other. Meanwhile, in the case of the duplicate node as described with reference to FIG. 5, data (1−β)dₗ+βdᵣ may be assigned identically to the decision node that is a duplication target.

Referring to FIG. 6, the processor 130 may generate one combined tree structure 63 by multiplying the node in the first lower tree structure 61 by 1-β, multiplying the node in the second lower tree structure 62 by β, and then adding the data of the respective nodes. The depth of the generated combined tree structure 63 may be reduced by 1 compared to the original tree structure, resulting in a total depth of 3.

The processor 130 may perform the comparison calculation on data of a root node 20′ in this combined tree structure 63 based on the input value in the above-described manner, and apply the comparison calculation result to each node in two lower tree structures 64 and 65 branching from the root node 20′ in the manner described above. Accordingly, the processor 130 may generate a new combined tree structure 66. A depth of the generated combined tree structure 66 may be 2, and two leaf nodes 71 and 72 may thus be connected to one root node 20″.

The processor 130 may perform again the comparison calculation of comparing data of the root node 20″ of the combined tree structure 66 with the corresponding input value, and output one final leaf node 71 as the result value based on a comparison calculation result value.

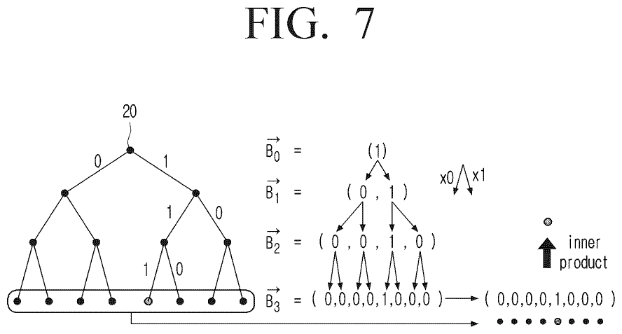

FIG. 7 is a view for explaining a method of making a decision by segmenting the decision tree according to another embodiment of the present disclosure.

The processor 130 may first generate the position identification vector corresponding to the root node 20 in the decision tree. The position identification vector may be a vector for indicating a position of the leaf node corresponding to the result value corresponding to the input value in the decision tree. The position identification vector may include the number of elements corresponding to the number of the decision trees. As described above, the input value may include the same number of input values as the number of the decision nodes. In a case shown in FIG. 7, the input value may include x1 to x7, and the data corresponding to each decision node may be d1 to d7.

The initial root node 20 may have only one tree. Accordingly, the position identification vector may have one element, and its initial value may be 1. That is, as shown in FIG. 7, the processor 130 may set an initial value of a position identification vector B to 1. The position identification vector may also be alternatively referred to as a position indication vector or a one-hot vector.

The processor 130 may perform the comparison calculation of comparing the input value with a calculated value acquired by calculating a value of the next node branching from the root node 20 and the position identification vector. The processor 130 may segment the tree structure while reflecting ß to each node to update the position identification vector to the position identification vector corresponding to a next depth in case of acquiring B, which is the comparison calculation result value.

Assume that the result value corresponding to the input value x exists in the second lower tree structure 62. Here, as shown in FIG. 6, a first element of the position identification vector of depth 1 is zero, and its second element may be 1 in case that the first lower tree structure 61 is multiplied by 1-β and the second lower tree structure 62 is multiplied by β. Therefore, the position identification vector may be (0,1).

The processor 130 may perform this operation multiple times. Accordingly, the position identification vector may be sequentially updated in the form of (0, 0, 1, 0), (0, 0, 0, 0, 1, 0, 0, 0), and the decision tree may also be segmented. As a result, 8 nodes equal to a total number of all the leaf nodes may remain at a final depth of 4. The processor 130 may detect the data of the leaf node (e.g., the 5th leaf node in the case of FIG. 7) having a value of 1 as the result value based on a value of a final position identification vector.

Meanwhile, according to another embodiment of the present disclosure, the processor 130 may perform the decision-making by using both the methods described with reference to FIGS. 6 and 7.

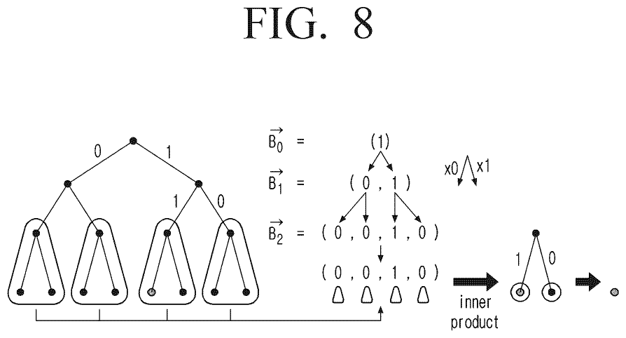

FIG. 8 is a view for explaining this embodiment in detail.

Referring to FIG. 8, the processor 130 may generate the position identification vector corresponding to the root node in the tree structure, perform the comparison calculation of comparing the input value with the calculated value acquiring by calculating the position identification vector and the value of the next node branching from the root node, and perform the segmentation operation of segmenting the tree structure a predetermined number of times while reflecting the comparison calculation result to the next node to update the position identification vector to the position identification vector corresponding to the next depth. The detailed segmentation method is described with reference to FIG. 7, and its redundant description is thus omitted.

Assume that a total depth of the decision tree is L and a set number of times is r. In this case, the processor 130 may generate one reduced tree structure by combining partial tree structures at depth L-r having the decision nodes at depth r as the root node with each other based on the position identification vector. The processor 130 may perform the reduction operation at least once on the reduced tree structure and output the result value corresponding to the input value. Here, a value of r may be predetermined as an optimal value by considering the number of bootstrapping required in a system, the number of homomorphic multiplication calculations between the encrypted messages, and the number of homomorphic calculations between the encrypted messages and the plaintext, or the like, and then stored in the memory 120. A manufacturer of the electronic device 100 or a manufacturer of the decision-making model may determine the optimal value of r by repeatedly performing experiments to acquire the result value by varying the value of r based on the above number of times after generating the decision-making model, and then store the same in the memory 120. The detailed reduction operation is described with reference to FIG. 6, and its redundant description is thus omitted.

In the various embodiments hereinabove, the reduction or updating operation is described as being performed using 1-β or β if the comparison calculation result value β is acquired, which is not necessarily limited thereto, and the operation described above may also be performed using 1 and B.

In addition, a hybrid algorithm for first reducing the decision tree and then segmenting the same is described with reference to FIG. 8, and may be implemented in a reverse order.

Meanwhile, the comparison calculation result is described as zero or 1 with reference to FIGS. 6 to 8, which is provided for convenience of explanation. If the data in the homomorphic encrypted message state are compared with each other, the comparison calculation result may also be output in the form of the encrypted message.

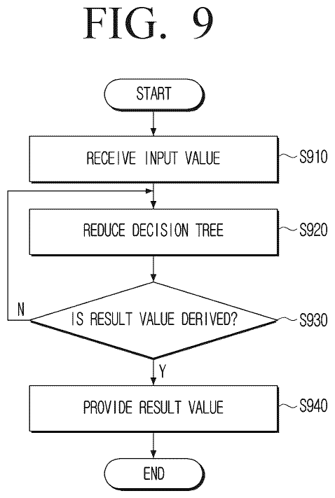

FIGS. 9, 10 and 11 are flowcharts for explaining a method of making a decision by an electronic device according to various embodiments of the present disclosure.

Referring to FIG. 9, the electronic device may perform the operation of reducing the pre-stored decision tree (S920) in case of receiving the input value (S910). In detail, the electronic device may perform the comparison calculation on the input value and the value of one of the nodes included in the tree structure, and reduce the tree structure by applying the comparison calculation result to the nodes at corresponding positions in the plurality of lower tree structures branching from the nodes and then combining the same. The detailed reduction algorithm is described in the description provided with reference to FIG. 6, and its redundant description is thus omitted.

The electronic device may output the data corresponding to the leaf node as the result value in case that a remaining node in the reduced decision tree is the leaf node. The electronic device may determine whether the result value is derived (S930) and perform the reduction operation again (S920) in case that the result value is not derived.

On the other hand, the electronic device may provide the result value (S940) in case that the result value is derived. The electronic device may provide the result value to the external device transmitting the input value, or may display the result value directly through a display embedded in or connected to the electronic device.

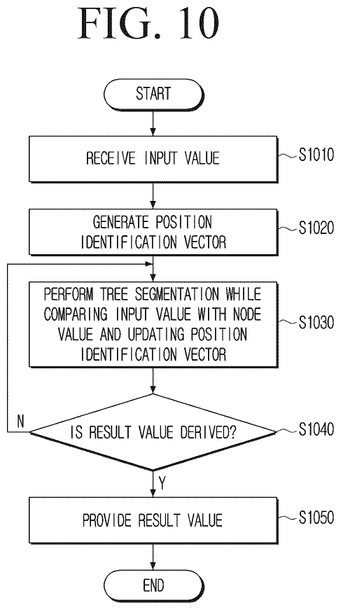

FIG. 10 is a flowchart for explaining a method of making a decision by using a segmentation operation. Referring to FIG. 10, the electronic device may generate the position identification vector corresponding to the root node in the tree structure (S1020) in case of receiving the input value (S1010).

The electronic device may segment the tree structure by performing the comparison calculation of comparing the input value with the calculated value acquired by calculating the position identification vector and the value of the next node branching from the root node, and reflecting the comparison calculation result to the next node to update the position identification vector to the position identification vector corresponding to the next depth (S1030). The detailed segmentation method is described with reference to FIG. 7, and its redundant description is thus omitted.

The electronic device may output the data corresponding to the leaf node as the result value in case that the tree structure, indicated by the position identification vector in the segmented tree structure, corresponds to the leaf node. The electronic device may perform the tree segmentation operation again (S1030) in case of determining that the result value is not derived by the segmentation operation (S1040).

On the other hand, the electronic device may provide the result value (S1050) in case that the result value is derived. As described above, the result value may be provided in various ways.

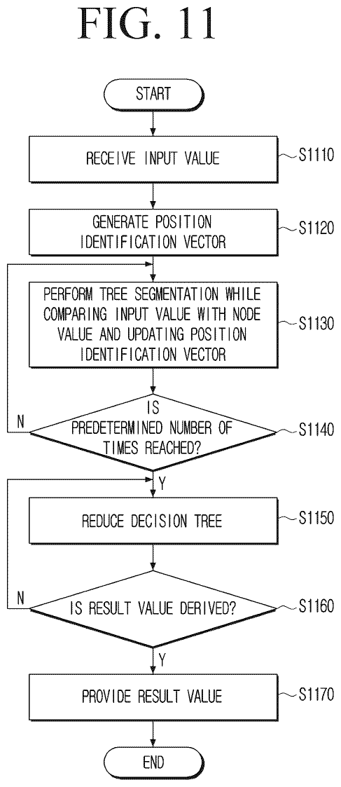

FIG. 11 is a flowchart for explaining a method of making a decision according to still another embodiment of the present disclosure. Referring to FIG. 11, the electronic device may generate the position identification vector (S1120) and perform the tree segmentation operation (S1130) in case of receiving the input value (S1110). These operations are the same as those described with reference to FIG. 10, and their redundant descriptions are thus omitted.

The electronic device may repeatedly perform the segmentation operation the predetermined number of times (S1140) and then combine the segmented tree structures with each other to acquire the reduced tree structure by using the position identification vector updated the predetermined number of times (S1150). The electronic device may provide the data corresponding to the leaf node as the result value corresponding to the input value (S1160 or S1170) in case that the remaining node in the reduced tree structure is the leaf node. The electronic device may perform the operation of reducing the decision tree once again (S1150) in case that the result value is not derived.

The method of making a decision described with reference to FIG. 11 is described in detail with reference to FIG. 8, and its redundant description is thus omitted. Referring to FIGS. 8 and 11, the electronic device is described as first performing the segmentation and updating operations, and then performing the reduction operation, is not necessarily limited thereto, and may be implemented to first perform the reduction operation and then perform the segmentation and updating operations.

The method of making a decision described with reference to FIGS. 9 to 11 may be performed by the electronic device 100 having the configuration of FIG. 3, is not necessarily limited thereto, and may be performed by devices having various modified configurations.

In addition, although not shown in FIGS. 9 to 11, the electronic device may be used for making a decision by first performing the preprocessing operation described with reference to FIGS. 4 and 5 and reorganizing the decision tree to be in an optimal state.

In detail, as shown in each flowchart of FIGS. 9 to 11, the method may further include performing the preprocessing operation of re-aligning the positions of the nodes for the largest number of nodes to be disposed in their corresponding positions among the nodes included in the plurality of lower tree structures with regard to the plurality of lower tree structures branching from one node in the tree structure.

Alternatively, the method may further include an operation of performing the preprocessing operation of matching the depths of the final leaf nodes of the lower tree structures each branching from the root node of the tree structure with each other by adding at least one duplicate node to the leaf nodes disposed at the middle depth in the tree structure, or may further include all the operations.

The method of making a decision described in the various embodiments described above may be used for various purposes. For example, the electronic device 100 may store the decision tree for determining a company's future strategy. In this case, data on standards or critical ranges for various items to identify the company's feature and determine the future strategy may be assigned to each decision node of the decision tree. The input value may include information on an items assigned to the respective decision nodes. For example, the input value may include various information in which x1 is an asset size, x2 is the number of employees, x3 is a stock price, x4 is a debt size, x5 is a cash holding ratio, x6 is information on products sold, x7 is the number of patents held, x8 is the number of customers, or the like. The electronic device may compare the input value with the data corresponding to each decision node and determine a final future strategy in the manner described above. Alternatively, the input value may include observational data observed while varying various experimental conditions if the decision-making model is used to understand a situation based on various experimental results. In this case, the data corresponding to the leaf node may include state information reflecting the various experimental results.

The method of making a decision described in the various embodiments hereinabove may be implemented in the form of the artificial intelligence model.

Although the various embodiments have been individually described hereinabove, each embodiment is not necessarily implemented individually, and may also be entirely or partially combined with at least one other embodiment and implemented together in one product.

According to the various embodiments above, the homomorphically encrypted encryption data may be assigned as the node value. In this case, the decision making may be made efficiently while minimizing the number of comparison calculations.

The various embodiments of the present disclosure may be implemented by software including an instruction stored in the machine-readable storage medium (for example, the computer readable storage medium).

In detail, provided is a non-transitory readable storage medium storing software for making a decision by sequentially performing the operations of acquiring the result value of the tree structure that corresponds to the input value by performing the operation of receiving the input value, performing the comparison calculation of comparing the input value with the value of one of the nodes included in the tree structure, and performing the reduction operation of reducing the tree structure at least once by applying the comparison calculation result to the nodes at the corresponding positions in the plurality of lower tree structures branching from the node and then combining the corresponding nodes with each other.

A device equipped with such a non-transitory readable medium may perform the operations such as the reduction, the segmentation, the vector updating, and the decision making described in the various embodiments described above.

Here, the term “non-transitory” in the non-transitory readable storage medium may only indicate that the storage medium is tangible without including a signal, and does not distinguish whether the data are semi-permanently or temporarily stored in the storage medium.

Alternatively, a program for performing the method according to the various embodiments described above may be distributed online through an application store. In case of the online distribution, at least a part of the computer program product may be at least temporarily stored or temporarily provided in a storage medium such as a memory of a server of a manufacturer, a server of an application store or a relay server.

In addition, each component (e.g., module or program) in the various embodiments may include a single entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the present disclosure has been described with reference to the accompanying drawings, the scope of the present disclosure is determined by the claims described below and should not be construed as being limited to the above-described embodiments or drawings. In addition, it should be clearly understood that improvements, changes, and modifications obvious to those skilled in the art of the present disclosure described in the claims are also included in the scope of the present disclosure.

What is claimed is:

1. An electronic device comprising:
a memory storing a tree-structured decision-making model for making a decision;
an interface for receiving an input value; and
a processor configured to:
acquire a result value of a tree structure that corresponds to the input value by performing a reduction operation of reducing the tree structure at least once,
wherein, the reduction operation includes a comparison calculation of comparing the input value with a value of one of nodes included in the tree structure is performed, and a comparison calculation result is added to nodes at corresponding positions in a plurality of lower tree structures branching from the node, and then the nodes are combined with each other.

2. The device as claimed in claim 1, wherein the processor is configured to:
perform a preprocessing operation of re-aligning positions of the nodes for the largest number of nodes to be disposed in their corresponding positions among the nodes included in the plurality of lower tree structures with regard to the plurality of lower tree structures branching from one node in the tree structure, and
store the re-aligned positions in the memory.

3. The device as claimed in claim 1, wherein the processor is configured to:
perform a preprocessing operation of matching depths of final leaf nodes of the lower tree structures each branching from a root node of the tree structure with each other by adding at least one duplicate node to the leaf node disposed at a middle depth in the tree structure.

4. The device as claimed in claim 1, wherein the processor is configured to:
generate a position identification vector corresponding to a root node in the tree structure,
perform the comparison calculation of comparing the input value with a calculated value acquired by calculating the position identification vector and a value of a next node branching from the root node,
perform an operation of segmenting the tree structure a predetermined number of times while reflecting a comparison calculation result to the next node to update the position identification vector to the position identification vector corresponding to a next depth,
combine the segmented tree structures with each other to acquire a reduced tree structure by using the position identification vector updated in the segmentation operation, and
output the result value corresponding to the input value by performing the reduction operation on the reduced tree structure at least once.

5. A method of making a decision by an electronic device which stores a tree-structured decision-making model for making a decision, the method comprising:
receiving an input value; and
acquiring a result value of a tree structure that corresponds to the input value by performing a reduction operation of reducing the tree structure at least once,
wherein, the reduction operation includes a comparison calculation of comparing the input value with a value of one of nodes included in the tree structure is performed, and a comparison calculation result is added to nodes at corresponding positions in a plurality of lower tree structures branching from the node, and then the nodes are combined with each other.

6. The method as claimed in claim 5, further comprising performing a preprocessing operation of re-aligning positions of the nodes for the largest number of nodes to be disposed in their corresponding positions among the nodes included in the plurality of lower tree structures with regard to the plurality of lower tree structures branching from one node in the tree structure.

7. The method as claimed in claim 5, further comprising performing a preprocessing operation of matching depths of final leaf nodes of the lower tree structures each branching from a root node of the tree structure with each other by adding at least one duplicate node to the leaf node disposed at a middle depth in the tree structure.

8. The method as claimed in claim 5, wherein the acquiring of the result value of the tree structure that corresponds to the input value includes:
generating a position identification vector corresponding to a root node in the tree structure, performing the comparison calculation of comparing the input value with a calculated value acquired by calculating the position identification vector and a value of a next node branching from the root node, and performing a segmentation operation of segmenting the tree structure a predetermined number of times while reflecting a comparison calculation result to the next node to update the position identification vector to the position identification vector corresponding to a next depth; and
combining the segmented tree structures with each other to acquire a reduced tree structure by using the position identification vector updated by the predetermined number of times, and outputting the result value corresponding to the input value by performing the reduction operation on the reduced tree structure at least once.
